(19) United States
(12) Patent Application Publication
(10) Pub. No.: US 2015/0054199 A1
(43) Pub. Date: Feb. 26, 2015

(54) DIE INSERT WITH LAYER HEATING, MOULDING PLATE WITH SUCH A DIE INSERT AND METHOD FOR OPERATING SUCH A DIE INSERT

(71) Applicant: GUENTHER Heisskanaltechnik GmbH, Frankenberg (DE)

(72) Inventors: Herbert Guenther, Allendorf (DE); Torsten Schnell, Lichtenfels (DE); Siegrid Sommer, Burgwald (DE); Frederic Zimmermann, Nurnberg (DE)

(21) Appl. No.: 14/390,139

(22) PCT Filed: Apr. 3, 2013
(86) PCT No.: PCT/EP2013/057051

§ 371 Date: Oct. 2, 2014

(30) Foreign Application Priority Data
Apr. 11, 2012 (DE) 10 2012 103 120.7

(51) Int. Cl. B29C 45/27

(52) U.S. Cl. CPC B29C 45/2737; B29C 2045/2745; B29C 2045/2753
USPC 264/404; 425/547

(57) ABSTRACT

Heated mould cavities of injection-moulding dies require long heating and cooling phases, with the result that the production unit numbers are low, the unit costs are high and the degree of efficiency is low as a result of the energy for temperature control. It is therefore a problem of the invention to eliminate or to reduce these disadvantages. According to the invention, this is solved by virtue of the fact that a die insert for delimiting, at least in sections, a mould cavity which is configured in a moulding plate of an injection-moulding die for producing components from a flowable material is provided with a main body which has a shaping front side for the mould cavity and a rear side which lies opposite the shaping front side, wherein the main body carries a layer heating means on the shaping front side thereof.

The invention relates to a die insert according to the preamble of claim 1, a moulding plate with such a die insert according to claim 16 and a method for operating such a die insert according to claim 22.

Injection moulding dies typically comprise a moulding plate with a cavity, into which a heated free-flowing material, in particular plastic, is introduced through at least one sprue opening. The free-flowing material sets inside the cavity and a component arises. The latter is then removed from the mould.

In the simplest case, the moulding plate is constituted in two parts and the mould halves are separated from one another for the removal from the mould. Embodiments are however known with a larger number of moulding plate fragments or so-called mobile slide gates in order that complex structures with undercuts can be removed from the mould.

A problem is the temperature distribution during the introduction of the free-flowing material into the cavity and during the setting. Known fault patterns thus caused are, amongst other things, bubbles, incompletely filled cavities, shear lines (also called tiger lines), joint lines and incomplete grain embossing. These defects are not only optical flaws, but also represent a risk in the case of components of importance for safety. The production of components with a high aspect ratio is particularly problematic. This is dictated by the ratio of the cavity depth proceeding from the sprue opening to the smallest lateral extension of the cavity, and by the overall size of the component. The smaller the component, the higher the aspect ratio. In the filling procedure for a cavity with a high aspect ratio, the free-flowing material cools down while still in motion, to an extent such that it gets stuck—shear lines arise and the cavity is possibly not completely filled—, the grain structure is not completely filled—incomplete grain embossing arises—and hardened film arises on the material front, so that a joint line arises when the two partial flows join up with one another.

With the demands on present-day components, these problems can no longer be overcome merely by high injection pressures. Heating devices at the sides of injection moulding nozzles and the moulding plate and cooling devices at the sides of the moulding plate are thus known, so that an influence can be exerted on the temperature distribution. This is intended to assist in preventing the faults from occurring.

The best-known methods for the temperature regulation of the moulding plate include channel structures for conveying temperature-regulated fluids, internal and external induction heating elements, infrared radiation when the die is opened and resistance heating elements.

Temperature regulation with water or oil as a heat transfer medium has become established, but has the drawback of poor efficiency. This occurs due to high losses in the supply line and sluggish dynamics in the temperature change. The latter is required in order to heat the moulding plate before and during the introduction of the free-flowing material into the cavity and then to set the free-flowing material by cooling. Moreover, heat regulation is limited to approx. 160° C. to 200° C.

Higher performances can be achieved with an induction heating element, but the integration into the injection moulding die is very intricate and costly. Moreover, relatively large components associated with mass are also heated here, whose temperature change is sluggish. This slows down the production cycles.

Heating by means of infrared radiation adopts the principle of thermal radiation. Here, the cavity surface is heated from the exterior by means of thermal radiation. The emission factor however is high and the efficiency of the heating low on account of usually very fine-machined surfaces of the cavity. Moreover, the achievable temperatures are limited by the size and power distribution of the emitters. Finally, the irradiation takes place with an opened die, as a result of which the production cycles are lengthened considerably.

In wt Werkstatttechnik online, Issue 99 (200) Vol. 11/12, pages 830-836 by Dipl.-Ing Ingo Brexeler and Nico Küls (BREXLER et al), a highly dynamic die temperature regulation is described in the article “Funktionale Oberflächen dynamisch temperiert”. The latter provides for mould inserts integrated into the die with a high-performance ceramic (CPH) and close-to-cavity cooling.

A drawback here, however, is that the heating elements according to BREXLER et al have a relatively large heated mass. This leads to slow cooling of the cavity, which involves long cycle times. This can be remedied only to a limited extent by the proposed cooling by means of the passage of a cooling medium through fluid channels.

The problem of the invention, therefore, is to overcome the drawbacks of the prior art and to provide a device with which the quickest possible cycle times are enabled in the production of components from a free-flowing material, in particular from plastic, with a high component quality. In particular, the device should enable a highly dynamic temperature regulation of the cavity, which can be adapted variably to the required temperatures, is easy to install, reliable in operation and cost-effective and has a high degree of efficiency.

The main features of the invention are stated in the characterising part of claims 1 and 22. Embodiments are the subject-matter of coordinated claim 16 and claims 2 to 15, 17 to 21 and 23 to 27.

With a die insert for delimiting, at least in sections, a cavity which is constituted in a moulding plate of an injection moulding die for producing components from a free-flowing material, with a main body which comprises a shaping front side for the cavity and a rear side lying opposite the shaping front side, the invention makes provision such that the main body carries a layer heating on its shaping front side.

Very rapid cycle times in the production of components from a free-flowing material are now possible with such a die insert, since the layer heating points in the direction of the cavity. Through-heating of the main body is not therefore necessary. The layer heating thus heats the shaping surface of the die insert extremely quickly. When the layer heating is deactivated, the small amount of thermal energy of this thin layer is very quickly carried away, in particular into the main body and from here into the moulding plate of a die.

Very rapid cyclical temperature profiles are achieved on account of the short heating times and the rapid cooling times as a result of the minimally heated mass of the layer heating. Since the heating takes place directly at the surface, it has no detrimental effect to cool the moulding plate continuously to a low temperature behind the die insert and/or the main body of the die insert. The setting rate of the free-flowing material can also be controlled by regulating the layer heating. By means of differing cross sections of the strip heating conductors, targeted distribution of the heat strip conductors and/or separate strip heating conductors, the temperature regulation can even take place in a locally adapted manner without notable thermal influences on the adjacent surface regions occurring. A highly dynamic temperature regulation of the cavity with high temperature gradients over the surface and a high degree of efficiency can thus be achieved.

With the die insert according to the invention, therefore, components can be produced from free-flowing material, in particular from plastic, which have a very high component quality. Thus, amongst other things, the flow of the free-flowing material is not hindered by a rapidly cooling melt front. Lower injection pressures are accordingly sufficient to fill the cavity. Closing units with small closing forces can thus be implemented, which leads to lower unit costs per component. In addition, an improved moulding of surface structures/graining, easier mould filling with thin-walled parts and a reduction in joint lines, shear and flow lines are thus achieved. For this purpose, it is possible for example to raise the surface of the cavity, shortly before the injection of the free-flowing material, to its glass or melting temperature and, after the filling procedure, to cool it down to the mould removal temperature, if need be assisted by a heat transfer medium flowing in cooling channels.

Furthermore, the installation of die inserts has been tried and tested in practice on many occasions, so that a die insert according to the invention with layer heating can also easily be installed in a straightforward manner.

The layer heating should be essentially between 10 to 500 thick. Local peak thicknesses of up to 2 mm can however also certainly be provided, especially when the surface contour of the cavity requires this. Thin- and thick-film technologies are particularly well suited for the production of the layer heating.

In a development of the invention, provision is made such that the layer heating comprises a strip heating conductor produced in thick-film technology. A preferred thickness of the strip heating conductor of 1 to 50 μm can thus be achieved. As can be seen, a very low mass to be heated thus results, which enables very dynamic temperature regulation. The materials silver (Ag), palladium (Pd), platinum (Pt), ruthenium (Ru) and gold (Au) or mixtures of these materials are particularly well suited for producing the strip heating conductor. For the formation of the surface contour, production of the strip heating conductor in a 3D printing process is recommendable, especially by inkjet processes, aerosol processes, dispensing or micro-dispensing. A tampon printing process or a screen printing process may also be expedient.

According to a more detailed embodiment of the layer heating according to the invention, the latter comprises a first electrical insulation layer produced in thick-film technology and covering the strip heating conductor in the direction of the front side. Persons handling the die are thus protected against electric shocks. Damage to the strip heating conductor due to short-circuits, e.g. caused by mechanical bridging, and due to mechanical damage is thus prevented. Finally, micro-waviness caused by the strip heating conductor can be compensated for by the insulation layer. In order to perform this function, the first electrical insulation layer should be between 10 to 50 μm thick, but local peak thicknesses of up to 2 mm may be necessary for the formation of the surface geometry of the cavity. With such a material thickness, the mass to be heated remains low and highly dynamic temperature regulation is possible. Glass, glass ceramic or enamel are particularly well suited as materials for the production of the first insulation layer. Optimisation of these materials with regard to a high thermal conductivity should be sought. The production as such preferably takes place in a 3D coating process, in order to replicate the surface geometry of the cavity. In particular, inkjet processes, aerosol processes, dispensing or micro-dispensing, tampon printing processes and screen printing processes, but also electrophoresis, spraying and immersion processes as well as other processes commonly used in enamel technology come into consideration for this.

According to a variant of the invention, provision is made such that the layer heating comprises a second electrical insulation layer produced in thick-film technology between the strip heating conductor and the main body. This is especially necessary when the main body is electrically conductive. The main body can also be made from a non-conductive material, but the bedding-in of a die insert in a cavity can usually be achieved more easily when use is made of a tool steel, in particular the same as the material of the moulding plate. This is because the main body then has the same thermal properties, in particular the same thermal expansion, as the moulding plate. The second electrical insulation layer should have a thickness between 10 and 50 μm. A continuously electrically insulating layer can thus be obtained, which in addition has only a small mass. Glass, glass ceramic or enamel, in particular, are suitable as materials for the second electrical insulation layer. Optimisation of these materials with regard to a high thermal conductivity should be sought. The production of the second electrical insulation layer preferably takes place by a 3D coating process, in order to replicate the surface geometry of the cavity. Inkjet processes, aerosol processes, dispensing or micro-dispensing, tampon printing processes and screen printing processes, but also electrophoresis, spraying and immersion processes as well as other processes commonly used in enamel technology are particularly well suited for this.

According to a more detailed embodiment of the strip heating conductor according to the invention, the latter is provided with connection contacts, which are disposed on a tongue of the main body, wherein the tongue can be positioned outside the cavity and on which a sealing face is constituted in the direction of the front side, said sealing face bordering the shaping region of the front side. The tongue and therefore the connection contacts can thus be positioned outside the cavity and are not subjected to the high injection pressures. In addition, a freer design of the connection contacts is possible outside the cavity, since no defined surface geometry has to be formed. Furthermore, operation of the layer heating with an external current source and/or control unit is possible. The sealing face can correspond to a mutually opposite sealing face of a moulding plate or to a further die insert. The cavity is thus reliably closed apart from desired openings.

In a further embodiment according to the invention, the strip heating conductor is provided with connection contacts, which are led through the main body in the direction of the rear side. The sealing face can thus be constituted completely by the moulding plates, as a result of which difficulties with matching are avoided. At the same time, the electrical connections can be led out of the cavity in a straightforward manner beneath the die insert.

To produce a reliable contact between the connection contacts and the strip heating conductor, a development is advantageous in which the connection contacts are acted upon by a force in the direction of the connection areas of the strip heating conductor. Alternatively or in addition, the connection contacts can be connected in a firmly bonded manner to the connection areas of the strip heating conductor.

Insofar as the connection contacts are led through the main body in the direction of the rear side, a variant of the invention is expedient in which an insulation body with one or more connection contacts is led through the main body, wherein the insulation body ends flush with the main body on the side of the layer heating and the connection contacts constitute contact areas on this side. The second electrical insulation layer should comprise at least one cutout in the region of the contact areas of the connection contacts. The strip heating conductor is preferably then deposited with its connection regions in thick-film technology onto the contact areas of the connection contacts.

An important development of the invention makes provision such that the layer heating is covered in the direction of the front side by a final contour layer, which constitutes the shaping front side. The surfaces and material properties of the cavities and the layer heating typically differ from one another. This makes the matching of the surfaces to achieve a uniform component surface difficult. With the contour layer according to the invention, this problem can be overcome in a straightforward manner.

According to an inventive design, the contour layer is essentially between 50 and 500 μm thick. This is sufficient to provide the quality of the surface contour and to cover a wave structure of a strip heating conductor. In addition, the contour layer can be finished after the deposition, so that for example common graining of the contour layer with the remaining contour surface of the cavity takes place. When use is made of identically reacting materials of the contour layer and the moulding plate, identical chemical graining can thus also be produced across the parting edges. Particularly preferably, the contour layer is essentially between 70 and 150 μm thick, but up to 2 mm material thickness can be provided in local peak regions. The mass of the contour layer is therefore also low and only slightly influences the highly dynamic temperature regulation by the layer heating.

In a variant of the invention, the contour layer is produced by detonation coating or by micro-forging. By means of detonation coating, fine microstructures in particular can be produced, the residual porosities whereof lie below 0.25%. In addition, the adhesive strengths lie at over 70 MPa and the contour layer has a long service life even with a large number of injection procedures. Metal powder is compacted under high pressure in a micro-forging process. For this purpose, the metal powder is compacted in particular by the use of water, current and compressed air. Very fine structures arise here, which can also be very complex.

In another variant of production, the contour layer is produced in electroplating technology or by a chemical coating process. With nickel electroplating processes, for example, nickel layers can be deposited, regulated by the current flow, in very short times with very high layer thicknesses. In contrast with this, the deposition of chemical nickel takes place without the application of an external electric current. The electrons required for the deposition of the nickel ions are generated by means of a chemical oxidation reaction in the bath itself. Particularly contour-true coatings are thus obtained. The electroless nickel-plating process is particularly well suited for layers up to 50 μm, since mechanical stresses arise in the layer with greater layer thicknesses and the deposition requires considerably more time than with the nickel electroplating process.

In the nickel electroplating process, a conductive substrate or a conductive intermediate layer is required. In the electroless nickel-plating process, at least one seeding is required with a non-conductive substrate, since a deposition begins on bare metal surfaces. The production of a conductive intermediate layer can be achieved by one of the aforementioned coating processes.

Before the deposition of the contour layer with an electroplating or electroless plating process, a chemically aggressive cleaning process should be carried out to ensure the adhesion of the layer. When use is made of a first electrical insulation layer not resistant to the cleaning agent, a variant of the invention makes provision such that a chemically resistant intermediate layer is disposed beneath the contour layer. Said intermediate layer thus has the properties of a protective layer and an adhesive layer. The durability of the die insert is thus particularly good. The intermediate layer can also be deposited by one of the previously described 2D or 3D coating processes.

Furthermore, a more detailed embodiment according to the invention makes provision such that the contour layer is made of a metal, in particular of a tool steel or of nickel. The latter are particularly well suited both with regard to the coating processes as well as the demands on the durability, adhesiveness, thermal conductivity, surface processing and surface quality.

According to an embodiment of the invention, the main body is produced from metal, in particular from a hard metal or a tool steel or an alloy comprising chromium, tungsten, nickel, molybdenum and carbon or an alloy comprising chromium, manganese, phosphorus, silicon, sulphur and carbon or an alloy comprising chromium, titanium, niobium, manganese and carbon. These materials can be adapted particularly well to a surrounding moulding plate. In addition, precisely hard metals are well suited for a coating with standard glasses.

According to an alternative embodiment according to the invention, the main body is produced from a ceramic. This enables a direct coating of the main body with the strip heating conductor. Moreover, ceramics are well suited for a coating with standard glasses.

A development of the invention relates to a layer temperature sensor, which is carried by the main body in the direction of the front side. Such a temperature sensor makes it possible to measure the temperature extremely rapidly and at the correct position on account of its low mass and the possibility of direct integration into the layer heating, e.g. between the strip heating conductors or directly above or below the strip heating conductor separated by a thin insulating layer. The determination of the temperature is thus particularly precise. Conventional temperature sensors with a sensor tip, on the other hand, would have to be positioned spaced apart from the contour-producing front side. However, since only a very thin layer is heated with the layer heating, the temperature in the region of the sensor tip would possibly diverge markedly. This is prevented by the layer temperature sensor according to the invention, which is particularly advantageous, since precisely the highly dynamic thermal changes in the layer heating or on the heater surface can be detected. A direct prompt regulation of the layer heating and of the injection die, in particular of the injection cycles, is thus also possible. The connections of the layer temperature sensor can take place similar to the design of the connections of the layer heating. Common or separate arrangements can be provided.

The invention also relates to a moulding plate for an injection moulding die for producing components from a free-flowing material, comprising a cavity bordered by a shaping surface, a sprue opening emerging into the cavity and a die insert holder, in which a die insert according to any one of the preceding claims is received. With such a moulding plate, the temperature regulation of the surface inside the cavity can take place particularly dynamically. The other previously described advantages of the die insert can also be implemented.

According to a development of the moulding plate according to the invention, the die insert is embedded with the shaping front side flush in the shaping surface of the cavity. The surface geometry over the die insert can thus be constituted without a detectable transition.

A special variant of the invention also makes a contribution to this, wherein the front side of the die insert and the shaping surface of the cavity are processed jointly by machining-down and/or grinding and/or polishing in the installation situation of the die insert in the die insert holder. Mismatches between the front side of the die insert and the surface of the cavity can thus be evened out by this processing. Fine structures can also be produced over the parting line.

The machining-down and/or grinding and/or polishing can particular preferably take place when the layer heating is heated. Minimal thermally induced contour fluctuations are thus taken into account in the production. The first insulation layer and the contour layer can thus be constituted particularly thin, without a wavy surface arising due to the strip heating conductor. The strip heating conductors can however also function as contour providers, insofar as this is desired for design reasons of the component. Ideally, the processing takes place at a temperature which corresponds to the subsequent operating temperature during the setting of the free-flowing material, i.e. the glass temperature of the free-flowing material. The surface contour of the die insert can therefore only be changed when the layer heating cools down. The component is however at least partially set and retains its shape.

In a further production variant, graining of the front side of the die insert and of the shaping surface of the cavity is produced jointly in the installation situation of the die insert in the die insert holder. Such technical or chemical graining can thus also be produced across the parting line between the die insert and the surface of the cavity.

In an advantageous installation variant according to the invention, the die insert is disposed in the region of a joint line position of the component. The side on which a joint line will be present can already be established before the production of the injection moulding die by an injection simulation. By means of local heating in the region of the joint line, the frontal hardened film becomes detached and the material fronts unite without material and/or visual defects.

For the uniform temperature regulation of the cavity and for the dissipation of the heat introduced by the layer heating and the injected free-flowing material, a development of the moulding plate makes provision such that fluid channels are constituted in the latter. A heat transfer medium can be conveyed through the latter in the process. Thus, for example, the moulding plate can be continuously cooled. The cooling does not have to be interrupted during the operation of the layer heating. The efficiency nonetheless remains very high on account of the low mass of the regions to be heated.

In a further development, the invention makes provision such that the die insert is fixed in the die insert holder by means of a detachable fixing means. The die insert can thus be replaced, reworked and processed separately from the moulding plate. In the case of a defect, the injection moulding die is also quickly ready for use again. The fixing means can preferably be actuated through an opening in the moulding plate lying outside the cavity. No handling inside the cavity is therefore necessary, and damage to the cavity surface is avoided. Such a fixing can be constituted by a threaded bore or a bore with a bayonet contour in the main body, and also by a bore which leads through the moulding plate into the die insert holder. A screw or a bayonet can then be fed through the latter and can be fixed in the bore in the main body. Alternatively, use could also be made of other tightening elements such as clamps, which engage with the moulding plate and the main body.

A floating mounting of the die insert in the die insert holder is also recommended. This reduces deformations of the die insert due to non-uniform thermal and/or pressure-induced stresses.

According to a development of the invention, the main body is coupled thermally with the die insert holder. As a result, the thermal energy introduced by the layer heating and the injected free-flowing material can thus be carried away as quickly as possible and in a straightforward manner from the region of the cavity. This can be achieved by means of a (large) contact area between the main body and the die insert holder. Helpful assistance is also offered by a heat-conducting paste between the main body and the die insert holder.

The invention also relates to a method for operating a previously described die insert in a cavity of a moulding plate of an injection moulding die for producing components from a free-flowing material, wherein heating of the layer heating first takes place by the application of a voltage, which is followed by the start of a filling cycle, wherein free-flowing material is introduced into the cavity, and wherein a reduction or removal of the voltage of the layer heating occurs before, during or after the filling cycle, before opening of the cavity after a cooling phase and removal of the at least partially set component are carried out.

As a result of the die insert according to the invention, particularly rapid injection cycles can be achieved by means of the method. The quality of the injected components is nonetheless particularly high on account of the highly dynamic temperature regulation by means of the layer heating.

An additional optional step in the method according to the invention comprises conveying the thermal energy of the free-flowing material and of the layer heating through the main body into the moulding plate during the cooling phase. In this way, the heat is carried away out of the region of the cavity as quickly as possible and in a straightforward manner in terms of design. The layer heating and the immediate surroundings of the cavity are already cooled to the temperature of the moulding plate shortly after the removal of the voltage, since only a very small mass has been heated, which moreover has a large surface for thermal conduction relative to its volume.

A variant of the method according to the invention makes provision for the conveying of a heat transfer medium through fluid channels inside the moulding plate during the cooling phase. The heat from the typically relatively voluminous moulding plates associated with mass can thus be carried away continuously, so that the dynamic temperature regulation can also function reliably over a large number of injection cycles.

The layer heating according to the invention also permits a method variant in which conveying of a heat transfer medium through fluid channels inside the moulding plate takes place during the heating of the layer heating and/or the filling cycle. The layer heating and the moulding plate can thus be temperature-regulated in a dual manner. It is conceivable for specific regions of the moulding plate to be heated by means of the transfer medium. Particularly preferable, however, is the option for the moulding plate to be cooled also when the layer heating is activated, in order to keep the temperature as low a level as possible. The thermal flux into the moulding plate upon deactivation of the layer heating from the latter and out of the cavity is correspondingly as rapid as possible.

Furthermore, a development of the method provides for heating of the layer heating to at least 150° C. before the start of the filling cycle. At such a temperature, a significant improvement in the filling behaviour with the majority of free-flowing materials is found compared to filling of a moulding plate that is not temperature-regulated and the components have a correspondingly high quality. A particular advantage of the layer heating is obtained through the possibility of being able to carry out the heating within 20 seconds, and particularly preferably within 8 seconds. The injection cycles are correspondingly rapid and a plurality of components can be produced per unit of time, which leads to low unit costs.

An addition to the method also contributes to achieving a highly dynamic temperature regulation, said addition providing for the holding of the temperature of the main body essentially at the temperature of a die insert holder receiving the die insert, and for the restriction of the heating essentially to the region of the layer heating. This holding of the temperature can also include the activation phases of the layer heating, so that as large a temperature gradient as possible exists between the layer heating and the main body. The main body can also comprise fluid channels for this purpose, which are preferably coupled with cooling channels of the moulding plate. The heat dissipation from the region of the cavity is particularly good as a result.

Further features, details and advantages of the invention emerge from the wording of the claims and from the following description of examples of embodiment based on the drawings. In the figures:

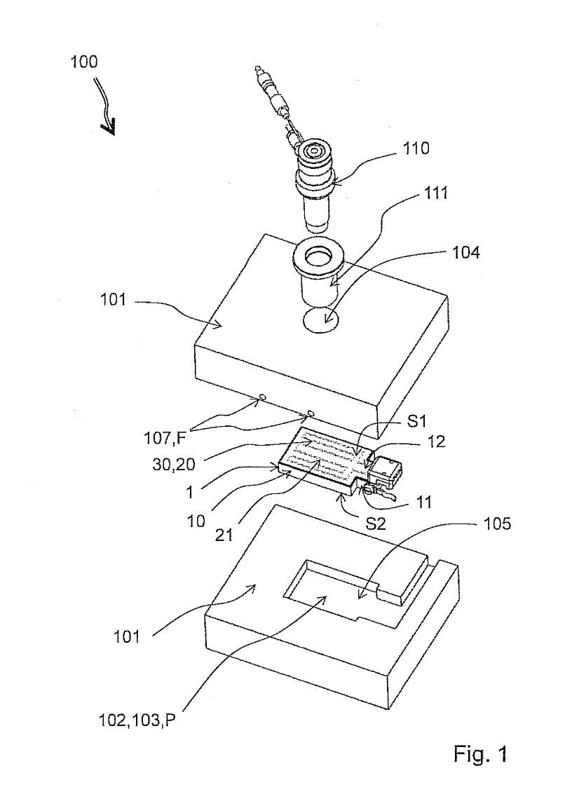

FIG. 1 shows an injection moulding die with a die insert in an exploded representation;

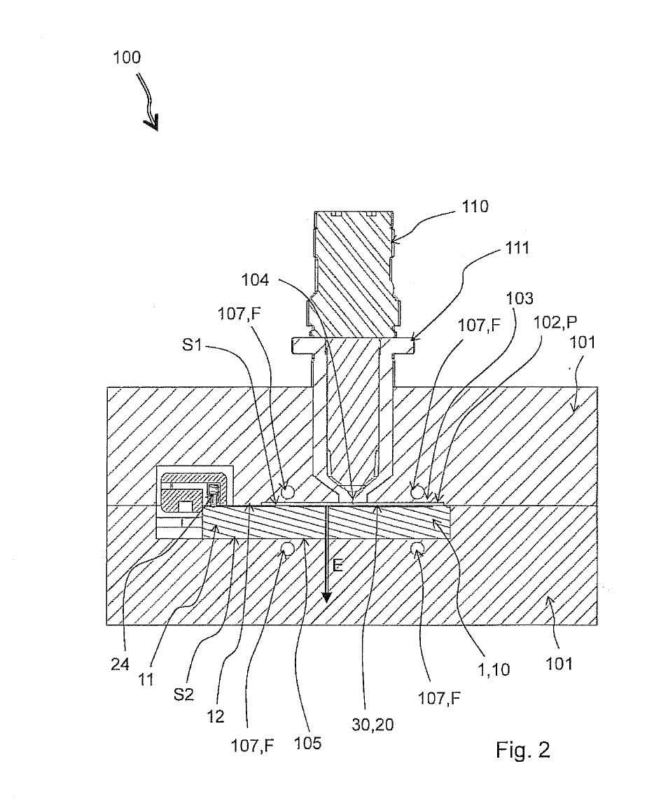

FIG. 2 shows a cross-section through an injection moulding die with a die insert;

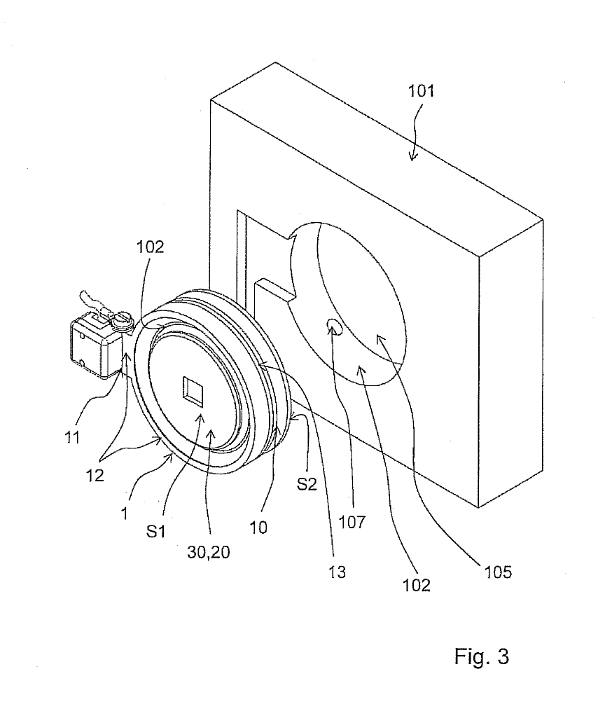

FIG. 3 shows a moulding plate and a die insert in an exploded view;

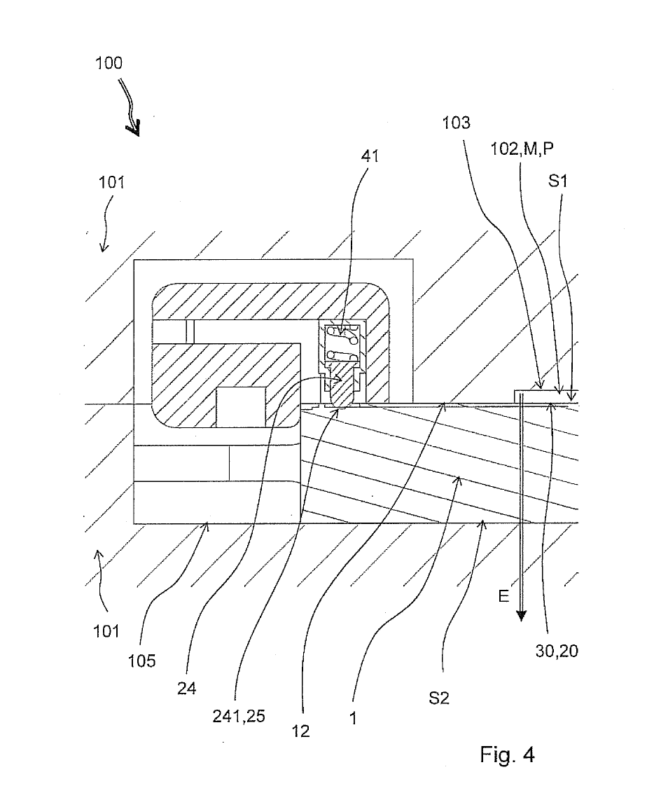

FIG. 4 shows a cross-section of a detailed view through an injection moulding die with a die insert in the region of the electrical connection of a layer heating;

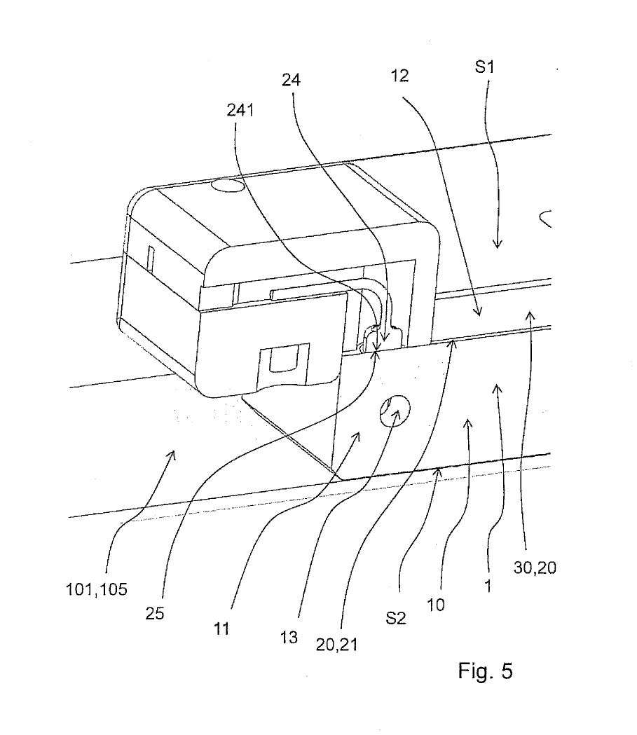

FIG. 5 shows a cross-section of a detailed view through a die insert in the region of the electrical connection of a laying heating;

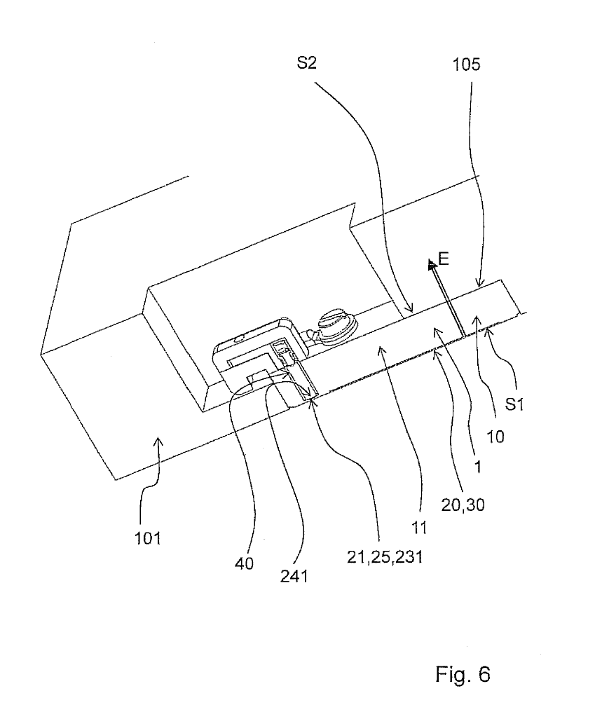

FIG. 6 shows a cross-section of a detailed view through a moulding plate with a die insert in the region of the electrical connection of a layer heating; and

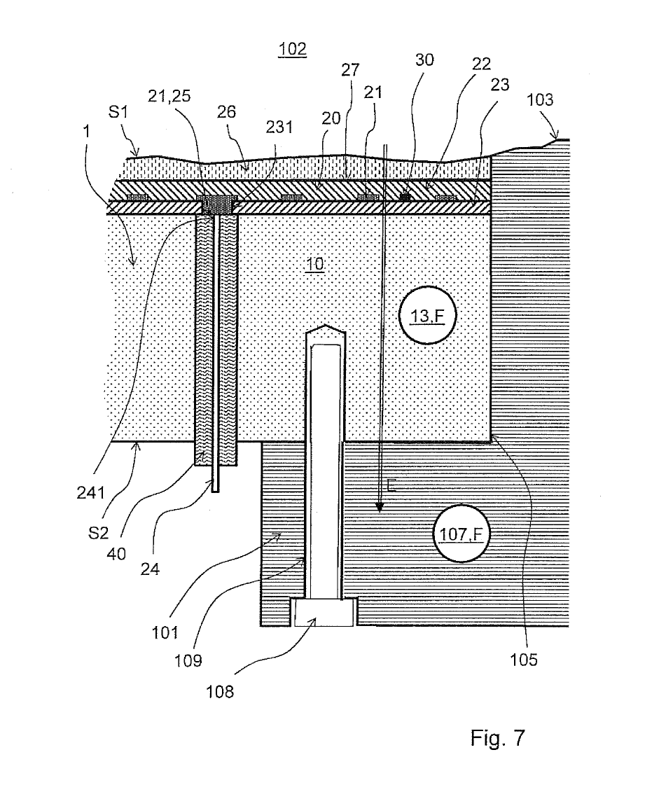

FIG. 7 shows a cross-section of a detailed view through a die insert with a layer heating in the region of the electrical connection of the layer heating.

FIG. 1 shows an injection moulding die 100 for producing components P from a free-flowing material M with a die insert 1 in an exploded view. FIG. 2 shows a cross-section through such an injection moulding die 100 with a die insert 1. Injection moulding die 100 according to FIGS. 1 and 2 has a two-part moulding plate 101. A cavity 102 with a shaping surface 103 is constituted in moulding plate 101, in particular between its two halves. The upper half of moulding plate 101 comprises a sprue opening 104 for filling free-flowing material M into the cavity. Inserted in sprue opening 104 is a nozzle insert 111, into which an injection moulding nozzle 110 in turn extends. It is not intended here to deal in detail with the design of injection moulding nozzle 110 with its nozzle tip, the material pipe, the housing, the material pipe head, the heating devices, the temperature sensor, its electrical connections and the connection of injection moulding nozzle 110 to a machine nozzle or a distributor.

For the temperature regulation of moulding plate 101, there is introduced into the latter a fluid channel 107 through which a heat transfer medium F can be conveyed. Constituted in the lower half of moulding plate 101 is a die insert holder 105 inside cavity 102, in which die insert 1 is received. In the embodiment shown here, die insert 1 is mounted in a floating manner in die insert holder 105. Die insert 1 and die insert holder 105 are thermally coupled, in particular by a relatively large contact area on rear side S2 of die insert 1. A heat-conducting paste can be introduced between die insert 1 and die insert holder 105 to assist with the thermal contact.

Furthermore, die insert 1 has shaping front side S1 pointing in the direction of cavity 102. Rear side S2 points, as described, in the direction of moulding plate 101. In the direction of rear side S2, die insert 1 comprises a main body 10, which carries layer heating 20 in the direction of front side S1. Layer heating 20 is essentially between 10 to 500 μm thick. A detailed view of a layer heating 20 can be found in FIG. 7. It can also be seen that layer heating 20 comprises a strip heating conductor 21 produced in thick-film technology. The latter is between 1 to 50 μm thick and the line cross-section and therefore the local electrical resistance are adapted to the thermal requirements called for locally. This enables the production of strip heating conductor 21 by means of a 3D coating process. In the case of flat surfaces, 2D processes such as screen printing, for example, can also be used.

Layer heating 20 also comprises a first electrical insulation layer 22 produced in thick-film technology and covering strip heating conductor 21 in the direction of front side S1. Said insulation layer is between 10 and 50 μm thick. It can be produced from glass, glass ceramic or enamel. First electrical insulation layer 22 is also produced in a 3D coating process. In the case of flat surfaces, 2D processes such as screen printing, for example, can also be used. There is also a second electrical insulation layer 23 disposed between strip heating conductor 21 and main body 10 and produced in thick-film technology. Second electrical insulation layer 23 is between 10 to 50 μm thick. It can be produced from glass, glass ceramic or enamel. Second insulation layer 23 is required if main body 10 is made of a metal, in particular of a tool steel. This selected material is electrically conductive.

Furthermore, layer heating 20 is covered in the direction of front side S1 by a final contour layer 26, which constitutes shaping front side S1. Contour layer 26 is essentially between 50 and 500 μm thick, although it comprises local peak thicknesses of up to 2 mm. Contour layer 26 can be produced by detonation coating or micro-forging. Production in electroplating technology or by a chemical coating process is also suitable as an alternative. Contour layer 26 is made of a metal, in particular of a tool steel or of nickel. If a non-electrically conductive material is selected for contour layer 26, the latter can assume the function of first electrical insulation layer 22, i.e. first electrical insulation layer 22 constitutes contour layer 26.

Die insert 1 also comprises a layer temperature sensor 30. The latter is carried by main body 10 in the direction of front side S1. In particular, it is integrated as a temperature sensor track into the layer structure of layer heating 20. The measurement of the temperature is based in particular on electrical voltages which correlate with the temperature.

Strip heating conductor 21 is provided with connection contacts 24, which are disposed on a tongue 11 of main body 10. Detailed views of such connection contacts 24 can be found in FIGS. 2, 3, 4 and 5. Tongue 11 is positioned outside cavity 102 and forms a sealing face 12 in the direction of front side S1, said sealing face bordering the shaping region of front side S1. This sealing face 12 corresponds to a sealing face of the upper half of moulding plate 101. The electrical connections of layer temperature sensor 30 lie similarly in the region of tongue 11.

With such an injection moulding die 100, a method can now be performed for the operation of die insert 1, wherein heating of layer heating 20 first takes place by the application of a voltage. A filling cycle is then started, in which free-flowing material M is introduced into cavity 102. During or after the filling cycle, the voltage of layer heating 20 is reduced or removed in order to carry away the heat from the region of the cavity into moulding plate 101, in particular by conducting thermal energy E of free-flowing material M and of layer heating 20 through main body 10 into moulding plate 101. The heat can be carried away from the latter by temperature regulation by means of a flow through fluid channels 107 of a heat transfer medium F. After a cooling phase, cavity 102 is opened and at least partially set component P is removed. The cooling of moulding plate 102 with heat transfer medium F can also take place during the heating of layer heating 20 and/or the filling cycle. Ideally, the temperature of main body 10 is thus held essentially at the temperature of die insert holder 105 and the heating by layer heating 20 is restricted to the region of layer heating 20, if appropriate including contour layer 26. The heating of layer heating 20 and therefore of front side S1 of die insert 1 takes place before the start of the filling cycle preferably to at least 150° C. On account of the small mass, this can be achieved in a very short time, for example within 8 seconds. The cooling after deactivation of layer heating 20 can also take place very rapidly. Alternatively, it can be influenced in a targeted manner by a temperature profile of layer heating 20.

FIG. 3 shows a moulding plate 101, in particular a half of the latter, and a die insert 1 in an exploded representation. Moulding plate 101 is designed for an injection moulding die for producing components from a free-flowing material. It has a cavity 102 in which a die insert holder 105 is constituted. Die insert 1 is received in the latter. In particular, die insert 1 is fixed by means of a detachable fixing means (not represented) in die insert holder 105. Die insert 1 is, as far as possible, floating in die insert holder 105. Main body 10 is thermally coupled with die insert holder 105, in particular by a relatively large contact area. The peripheral groove in die insert 1 becomes, as a result of installation in die insert holder 105, a fluid channel 13 to which a heat transfer medium is fed through a fluid channel 107 in moulding plate 101. The heat transfer medium can thus be conveyed directly along die insert 1.

Die insert 1 has a shaping front side S1 pointing in the direction of cavity 102, said front side being constituted three-dimensionally, as can be seen. A rear side S2 of die insert 1 points in the direction of moulding plate 101. In the direction of this rear side S2, die insert 1 has a main body 10 which, in the direction of front side S1, carries a layer heating 20 and a layer temperature sensor 30. For the more detailed design, the reference is made at this point to the description of FIGS. 1, 2 and 7. Layer heating 20 is, furthermore, covered in the direction of front side S1 by a final contour layer 26, which constitutes shaping front side S1, this also being described in greater detail in the embodiments in respect of FIGS. 1, 2 and 7.

Layer heating 20 and layer temperature sensor 30 each have connection contacts which are disposed on tongue 11 of main body 10, wherein tongue 11 is positioned outside cavity 102. In the direction of front side S1, tongue 11 constitutes a sealing face 12, which borders the shaping region of front side S1. As can be seen, sealing face 12 radially encompasses the entire shaping front side S1. In this way, the seal is continuous and sealing problems at transitions are avoided.

FIGS. 4, 5 and 6 each show a cross-section of a detailed view through a die insert 1 in the region of the electrical connection of a layer heating 20. FIG. 4 shows two halves of a moulding plate 101 in the closed position, whilst only one half of moulding plate 101 can be seen in FIGS. 5 and 6.

Moulding plates 101 of FIGS. 4 to 6 each constitute a cavity 102 with a shaping surface 103. Moreover, they have a die insert holder 105, in which die insert 1 is received.

Die insert 1 has a shaping front side S1 pointing in the direction of cavity 102 and a rear side S2 pointing in the direction of moulding plate 101. In the direction of rear side S2, die insert 1 has a main body 10 which, in the direction of front side S1, carries a layer heating 20. Moreover, it also carries here a layer temperature sensor 30. For the structure of layer heating 20 with its strip heating conductor 21 and layer temperature sensor 30, reference is made at this point to the embodiments in respect of FIGS. 1, 2 and 7. Strip heating conductor 21 is provided in each case with connection contacts 24. The same applies to layer thermoelement 30.

According to FIGS. 4 and 5, connection contacts 24 are each disposed on a tongue 11 of main body 10. Connection contacts 24 lie here on front side S1, for which reason tongue 11 is positioned outside cavity 102. Constituted on tongue 11 in the direction of front side S1 is a sealing face 12, which borders the shaping region of front side S1. Connection contacts 24 thus lie outside the shaping region of front side S1. A connection area 25 of strip heating conductor 21 is exposed on tongue 11, in particular connection area 25 is not covered by a first insulation layer 22 and/or a contour layer 26. Connection contact 24 with a contact area 241 is constituted corresponding to connection area 25. According to FIG. 4, connection contact is pressed with its contact area 241 by means of an energy storage mechanism, in particular a spring element 41, onto connection area 25. In contrast, contact area 241 of connection contact 24 according to FIG. 5 is connected in a firmly bounded manner to connection area 25, in particular by soldering or welding.

A particular feature can be seen in FIG. 5, where a fluid channel 13 is constituted in main body 10, so that the latter can be cooled particularly quickly.

According to FIG. 6, strip heating conductor 21 and layer thermoelement 30 are provided with connection contacts 24, which are led through main body 10 in the direction of rear side S2. For this purpose, an insulation body 40 is passed with connection contacts 24 through main body 10. Insulation body 40 and connection contacts 24 end flush with main body 10 on the side of layer heating 20 and connection contacts 24 form here contact areas 241. In the region of these contact areas 241, second electrical insulation layer 23 comprises a cutout 231. Furthermore, connection contacts 24 are connected in a firmly bonded manner to connection areas 25 of strip heating conductor 21. In particular, strip heating conductor 21 with its connection contacts 24 is deposited in thick-film technology on contact areas 241 of connection contacts 24.

A detailed view of a connection according to FIG. 6 and the structure of layer heating 20 and of layer temperature sensor 30 can be found in FIG. 7. A detail view is shown here of a die insert 1 in a cavity 102 in a moulding plate 101 of an injection moulding die for producing components from a free-flowing material. A shaping front side S1 of die insert 1 points in the direction of cavity 102 and a rear side S2 points in the direction of moulding plate 101. A main body 10 of die insert 1 pointing in the direction of rear side S2 carries a layer heating 20 in the direction of front side S1.

Constituted in moulding plate 101, in particular in the region of cavity 102, is a die insert holder 105, in which die insert 1 is received. Die insert 1 is fixed in die insert holder 105 by means of a detachable fixing means 108, in particular a screw. Fixing means 108 can be actuated through an opening 109 in moulding plate 101, said opening lying outside cavity 102. As can be seen here, the screw engages in a threaded bore 14 on rear side S2 of main body 10. Main body 10 is made of a tool steel, or of an alloy comprising chromium, tungsten, nickel, molybdenum and carbon or an alloy comprising chromium, manganese, phosphorus, silicon, sulphur and carbon or an alloy comprising chromium, titanium, niobium, manganese and carbon.

By means of a thermal contact between main body 10 and die insert holder 105 or moulding plate 101, thermal energy E can be conducted out of cavity 102 and layer heating 20 through main body 10 into moulding plate 101. For the rapid dissipation of thermal energy E, a fluid channel 107 is also provided in moulding plate 101 and a fluid channel 13 in main body 10, through which a heat transfer medium F can be conveyed in each case.

Layer heating 20 comprises a strip heating conductor 21 produced in thick-film technology, which is between 1 to 50 μm thick. It is made of Ag, Pd, Pt, Ru, Au or mixtures thereof. It is produced in a 2D or a 3D coating process, for which, in particular, inkjet processes, aerosol processes, dispensing or micro-dispensing, tampon printing processes and screen printing processes are suitable.

Furthermore, layer heating 20 comprises a first electrical insulation layer 22 produced in thick-film technology and covering strip heating conductor 21 in the direction of front side S1. Said first electrical insulation layer is between 10 to 50 μm thick, is made of glass, glass ceramic or enamel and is produced in a 2D or a 3D coating process. Inkjet processes, aerosol processes, dispensing or micro-dispensing, tampon printing processes and screen printing processes, but also electrophoresis, spraying or immersion processes or other processes commonly used in enamel technology are also suitable for this.

Between strip heating conductor 21 and main body 10, layer heating 20 comprises a second electrical insulation layer produced in thick-film technology. Said second electrical insulation layer is between 10 to 50 μm thick, is made of glass, glass ceramic or enamel, and is produced in a 2D or a 3D coating process. Inkjet processes, aerosol processes, dispensing or micro-dispensing, tampon printing processes and screen printing processes, but also electrophoresis, spraying or immersion processes or other processes commonly used in enamel technology are also suitable for this.

Strip heating conductor 21 is provided with connection contacts 24, which are led through main body 10 in the direction of rear side S2. For this purpose, an insulation body 40 with connection contacts 24 is led through main body 10. Said insulation body ends flush with main body 10 on the side of layer heating 20 and connection contacts 24 constitute contact areas 241 on this side. Second electrical insulation layer 23 has a cutout 231 in the region of contact areas 241. Due to the fact that strip heating conductor 21 with its connection regions is deposited in thick-film technology on contact areas 241 of connection contacts 24, a firmly bonded connection exists between connection contacts 24 and connection areas 25 of strip heating conductor 21.

Embedded between first electrical insulation layer 22 and second electrical insulation layer 23, main body 10 also carries a layer temperature sensor 30 in the direction of front side 51. Its electrical connection contacts, which can be constituted similar to those of layer heating 20, cannot be seen.

Layer heating 20 is covered in the direction of front side S1 by a final contour layer 26, which constitutes shaping front side S1. Contour layer 26 is essentially between 50 and 500 μm thick. A material thickness of up to 2 mm is provided only in small local peak regions. Furthermore, the counter layer is made of a metal, in particular of a tool steel or of nickel. It is produced by a detonation coating process or by micro-forging. Alternatively, production in electroplating technology or by a chemical coating process comes into consideration. In order to achieve a very hard-wearing fixing of contour layer 26, a chemically resistant intermediate layer 27 is disposed beneath the latter. Said intermediate layer protects first electrical insulation layer 22 during surface processing by means of aggressive cleaning agents. Intermediate layer 27 then constitutes an adhesive layer for contour layer 20.

As can be seen, die insert 1 is embedded with front side S1 flush in shaping surface 103 of cavity 102. For this purpose, front side S1 of die insert 1 and shaping surface 103 of cavity 102 are processed jointly by machining-down, grinding and polishing in the shown installation situation of die insert 1 in die insert holder 105. The processing takes place in particular when layer heating 20 is heated. Moreover, graining on front side S1 and on shaping surface 103 of cavity 102 has been produced jointly in the installation situation of die insert 1 in die insert holder 105.

The invention is not limited to one of the embodiments described above, but rather can be modified in diverse ways. In particular, layer heating 20 can, depending on the material selection, comprise only one or even no insulation layer, or first insulation layer 22 and contour layer 26 can be constituted by a single layer. Combinations of the various electrical connections are also possible, and differing numbers of layer thermoelements 30 and strip heating conductors 20 can be provided in a common layer structure. Peripheral boundaries of die insert 1 lying inside cavity 101 can be located in a targeted manner in visible edges or design beading of the component. Finally, there is in principle also the possibility of depositing contour layer 26 across the peripheral boundary of die insert 1 in the installation situation in die insert holder 105, so that a flowing transition is created between die insert 1 and shaping surface 103 of cavity 102. The arrangement of a plurality of die inserts 1 in a single cavity 102 is also conceivable.

All the features and advantages emerging from the claims, the description and the drawing, including design details, spatial arrangements and process steps, can be essential to the invention both in themselves and also in the most diverse combinations.

List of reference numbers

| | |
|---|---|
| 1 | Die insert |
| 10 | Main body |
| 11 | Tongue |
| 12 | Sealing face |
| 13 | Fluid channel |
| 14 | Threaded bore |
| 20 | Layer heating |
| 21 | Strip heating conductor |
| 22 | First electrical insulation layer |
| 23 | Second electrical insulation layer |
| 231 | Cutout (second electrical insulation layer) |
| 24 | Connection contact |
| 241 | Contact area (of connection contact) |
| 25 | Connection area |
| 26 | Contour layer |
| 27 | Intermediate layer |
| 30 | Layer temperature sensor |
| 40 | Insulation body |
| 41 | Spring element |
| 100 | Injection moulding die |
| 101 | Moulding plate |
| 102 | Cavity |
| 103 | Shaping surface (cavity) |
| 104 | Sprue opening |
| 105 | Die insert holder |
| 107 | Fluid channel |
| 108 | Fixing means |
| 109 | Opening |
| 110 | Injection moulding nozzle |
| 111 | Nozzle insert |
| E | Thermal energy |
| F | Heat transfer medium |
| M | Material |
| P | Component |
| S1 | Front side |
| S2 | Rear side |

1. A die insert (1) for delimiting, at least in sections, a cavity (102) which is constituted in a moulding plate (101) of an injection moulding die (100) for producing components (P) from a free-flowing material (M), with a main body (10) which comprises a shaping front side (S1) for the cavity (102) and a rear side (S2) lying opposite the shaping front side (S1), characterised in that the main body (10) carries a layer heating (20) on its shaping front side (S1).

2. The die insert (1) according to claim 1, characterised in that the layer heating (20) comprises a strip heating conductor (21) produced in thick-film technology.

3. The die insert (1) according to claim 2, characterised in that the layer heating (20) comprises a first electrical insulation layer (22) produced in thick-film technology and covering the strip heating conductor (21) in the direction of the front side (S1).

4. The die insert (1) according to claim 2, characterised in that the layer heating (20) comprises a second electrical insulation layer (23) produced in thick-film technology between the strip heating conductor (21) and the main body (10).

5. The die insert (1) according to claim 2, characterised in that the strip heating conductor (21) is provided with connection contacts (24), which are disposed on a tongue (11) of the main body (10), wherein the tongue (11) can be positioned outside the cavity (102) and a sealing face (12) is constituted on the tongue (11) in the direction of the front side (S1), said sealing face bordering the shaping region of the front side (S1).

6. The die insert (1) according to claim 2, characterised in that the strip heating conductor (21) is provided with connection contacts (24), which are led through the main body (10) in the direction of the rear side (S2).

7. The die insert (1) according to claim 1, characterised in that the layer heating (20) is covered in the direction of the front side (S1) by a final contour layer (26), which constitutes the shaping front side (S1).

8. The die insert (1) according to claim 7, characterised in that the contour layer (26) is essentially between 50 and 500 μm thick.

9. The die insert (1) according to claim 7, characterised in that the contour layer (26) is produced by detonation coating or by micro-forging.

10. The die insert (1) according to claim 7, characterised in that the contour layer (26) is produced in electroplating technology or by a chemical coating process.

11. The die insert (1) according to claim 7, characterised in that the contour layer (26) is made of a metal, in particular of a tool steel or of nickel.

12. The die insert (1) according to claim 7, characterised in that a chemically resistant intermediate layer (27) is disposed beneath the contour layer (26).

13. The die insert (1) according to claim 1, characterised in that the main body (10) is produced from hard metal or tool steel or an alloy comprising chromium, tungsten, nickel, molybdenum and carbon or an alloy comprising chromium, manganese, phosphorus, silicon, sulphur and carbon or an alloy comprising chromium, titanium, niobium, manganese and carbon.

14. The die insert (1) according to claim 1, characterised in that the main body (10) is produced from a ceramic.

15. The die insert (1) according to claim 1, characterised in that the main body (10) carries a layer temperature sensor (30) in the direction of the front side (S1).

16. A moulding plate (101) for an injection moulding die (1) for producing components (P) from a free-flowing material (M), comprising a cavity (102) bordered by a shaping surface (103), a sprue opening (104) emerging into the cavity (102) and a die insert holder (105), in which a die insert (1) according to any one of the preceding claims is received.

17. The moulding plate (101) according to claim 16, characterised in that the die insert (1) is embedded with the shaping front side (S1) flush in the shaping surface (103) of the cavity (102).

18. The moulding plate (101) according to claim 16, characterised in that the front side (S1) of the die insert (1) and the shaping surface (103) of the cavity (102) are processed jointly by machining-down and/or grinding and/or polishing in the installation situation of the die insert (1) in the die insert holder (105).

19. The moulding plate (101) according to claim 16, characterised in that fluid channels (107) are constituted in the latter.

20. The moulding plate (101) according to claim 16, characterised in that the die insert (1) is fixed in the die insert holder (105) by means of a detachable fixing means (108).

21. The moulding plate (101) according to claim 16, characterised in that the main body (10) is thermally coupled with the die insert holder (105).

22. A method for operating a die insert (1) according to claim 1 in a cavity (102) of a moulding plate (101) of an injection moulding die (100) for producing components (P) from a free-flowing material (M), characterised by the following steps:
heating of the layer heating (20) by the application of a voltage;
subsequent starting of a filling cycle in which free-flowing material (M) is introduced into the cavity (102);
reduction or removal of the voltage of the layer heating (20) before, during or after the filling cycle;
opening of the cavity (102) after a cooling phase and removal of the at least partially set component (P).

23. The method according to claim 22, characterised by the following step:
conducting of the thermal energy (E) of the free-flowing material (M) and of the layer heating (20) through the main body (10) into the moulding plate (101) during the cooling phase.

24. The method according to claim 22, characterised by the following step:
conveying of a heat transfer medium (F) through fluid channels (107) inside the moulding plate (101) during the cooling phase.

25. The method according to claim 22, characterised by the following step:
conveying of a heat transfer medium (F) through fluid channels (107) inside the moulding plate (101) during the heating of the layer heating (20) and/or the filling cycle.

26. The method according to claim 22, characterised by the following step:
heating of the layer heating (20) to at least 150° C. before the start of the filling cycle.

27. The method according to claim 22, characterised by the following step:
holding of the temperature of the main body (10) essentially at the temperature of a die insert holder (105) receiving the die insert (1), and
restricting the heating essentially to the region of the layer heating (20).
